(19) United States
(12) Patent Application Publication
(10) Pub. No.: US 2024/0253484 A1
(43) Pub. Date: Aug. 1, 2024

(54) TRAVELING NONCONTACT POWER SUPPLY SYSTEM

(71) Applicant: TOYOTA JIDOSHA KABUSHIKI KAISHA, Toyota-shi (JP)

(72) Inventors: Toshiya HASHIMOTO, Miyoshi-shi (JP); Masato MAEMURA, Nisshin-shi (JP); Shogo TSUGE, Fuji-shi (JP); Ryosuke IKEMURA, Susono-shi (JP)

(73) Assignee: TOYOTA JIDOSHA KABUSHIKI KAISHA, Toyota-shi (JP)

(21) Appl. No.: 18/400,002

(22) Filed: Dec. 29, 2023

(30) Foreign Application Priority Data
Feb. 1, 2023 (JP) 2023-014283

(51) Int. Cl. B60L 53/126; B60L 53/30; B60L 58/15; H02J 50/12; H02J 50/80

(52) U.S. Cl. CPC B60L 53/126; B60L 53/305; B60L 53/32; B60L 58/15; H02J 50/12; H02J 50/80; B60L 2240/30

(57) ABSTRACT

A traveling noncontact power supply system of the present disclosure supplies electric power from a road-side power supply device to a vehicle-side power receiving device in a contactless manner. The road-side power supply device has a first communication device for wide-area wireless communication and a second communication device for short-range wireless communication. The vehicle-side power receiving device has a third communication device for wide-area wireless communication and a fourth communication device for short-range wireless communication. The vehicle can perform regenerative braking to charge a power storage device. If the compatibility between the road-side power supply device and the vehicle-side power receiving device is satisfied, and there is a possibility that the power storage device is overcharged, predetermined charging control is performed by short-range wireless communication to prevent overcharging of the power storage device. If there is no possibility, the predetermined charging control by short-range wireless communication is not performed.

### CROSS-REFERENCE TO RELATED APPLICATION

This application claims priority to Japanese Patent Application No. 2023-014283 filed on Feb. 1, 2023, incorporated herein by reference in its entirety.

### BACKGROUND

### 1. Technical Field

The present disclosure relates to a traveling noncontact power supply system.

### 2. Description of Related Art

Japanese Unexamined Patent Application Publication No. 2013-240132 (JP 2013-240132 A) discloses a technique in which a vehicle includes a communication unit that performs wireless communication between a power transmission device and a power reception device, and the communication unit switches the communication range between wide-area wireless communication and narrow-area wireless communication.

### SUMMARY

In the traveling noncontact power supply for supplying, in a noncontact manner, power from a power supply device to a vehicle that is traveling and equipped with a power receiving device, high-speed and high-capacity communication is required for supplying power while the vehicle is traveling. Therefore, information such as vehicle identification information, required power, billing, vehicle specifications, and vehicle location is exchanged in advance through wide-area wireless communication, and in narrow-area wireless communication, vehicle identification information is collated and power supply is started. Constantly performing narrow-area wireless communication may be wasteful in some cases, whereas not performing the narrow-area wireless communication may result in overcharging of a power storage device. Therefore there is room for improvement.

The present disclosure has been made in view of the above issues, and an object of the present disclosure is to provide a traveling noncontact power supply system that can suppress unnecessary narrow-area wireless communication while suppressing overcharging of a power storage device.

In order to solve the above-described issues and achieve the object, the traveling noncontact power supply system according to the present disclosure is a traveling noncontact power supply system that supplies, in a noncontact manner, power from a road-side power supply device to a traveling vehicle in which a vehicle-side power receiving device is mounted, and charges a power storage device mounted on the vehicle. The road-side power supply device includes a first communication device that performs wide-area wireless communication with the vehicle-side power receiving device, and a second communication device that performs narrow-area wireless communication with the vehicle-side power receiving device. The vehicle-side power receiving device includes a third communication device that performs the wide-area wireless communication with the road-side power supply device, and a fourth communication device that performs the narrow-area wireless communication with the road-side power supply device. The vehicle is able to charge the power storage device by performing regenerative braking. When compatibility between the road-side power supply device and the vehicle-side power receiving device is satisfied and there is a possibility that the power storage device is overcharged, predetermined charging control is performed through the narrow-area wireless communication, and when compatibility between the road-side power supply device and the vehicle-side power receiving device is satisfied and there is no possibility that the power storage device is overcharged, the predetermined charging control is not performed through the narrow-area wireless communication.

Accordingly, the traveling noncontact power supply system according to the present disclosure can suppress unnecessary narrow-area wireless communication while suppressing overcharging of the power storage device.

Further, in the above, as the predetermined charging control, the regenerative braking may be permitted when a power command is able to be issued from the vehicle-side power receiving device to the road-side power supply device through the narrow-area wireless communication, and the regenerative braking may be prohibited when the power command is not able to be issued from the vehicle-side power receiving device to the road-side power supply device.

Accordingly, it is possible to suppress overcharging of the power storage device due to the regenerative braking while the traveling noncontact power supply is performed.

Further, in the above, as the predetermined charging control, a power request may be made from the vehicle-side power receiving device to the road-side power supply device through the narrow-area wireless communication when a brake of the vehicle is on, and no power request may be made from the vehicle-side power receiving device to the road-side power supply device through the narrow-area wireless communication when the brake is off.

Accordingly, when the regenerative braking is performed while the traveling noncontact power supply is performed, it is possible to suppress overcharging of the power storage device by making a power request through the narrow-area wireless communication.

The traveling noncontact power supply system according to the present disclosure has the effect of suppressing unnecessary narrow-area wireless communication while suppressing overcharging of the power storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a wireless power transfer system in an embodiment;

FIG. 2 is a diagram showing the overall configuration of the wireless power transfer system;

FIG. 3 is a schematic diagram for explaining wide area wireless communication in the wireless power transfer system;

FIG. 4 is a block diagram for explaining the functional configuration of the power transmission ECU;

FIG. 5 is a block diagram for explaining the functional configuration of the vehicle ECU;

FIG. 6 is a diagram for explaining the power transmission process;

FIG. 7 is a sequence diagram showing a case where communication using wide area wireless communication is performed between the vehicle and the supply device;

FIG. 8 is a sequence diagram showing the operation after the power supply from the power supply device to the vehicle during running ends;

FIG. 9 is a flowchart showing an example of control performed by the wireless power transfer system according to the embodiment; and

FIG. 10 is a flowchart showing another example of control performed by the wireless power transfer system according to the embodiment.

### DETAILED DESCRIPTION OF EMBODIMENTS

An embodiment of a traveling noncontact power supply system according to the present disclosure will be described below. This embodiment is not intended to limit the present disclosure.

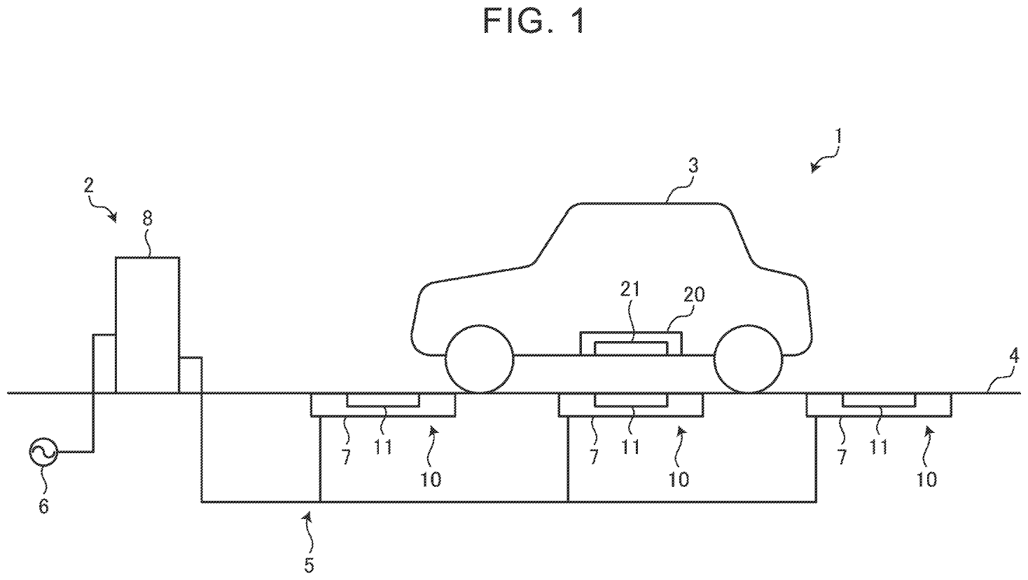

FIG. 1 is a schematic diagram showing a wireless power transfer system according to an embodiment. The wireless power transfer system 1 is a traveling noncontact power supply system that includes a supply facility 2 and a vehicle 3 and supplies electric power from the supply facility 2 to the vehicle 3 that is traveling. The supply facility 2 is a facility that supplies electric power to the traveling vehicle 3 in a contactless manner. The vehicle 3 is an electrified vehicle that can be charged with electric power supplied from an external power source, such as a battery electric vehicle (BEV) or a plug-in hybrid electric vehicle (PHEV).

This wireless power transfer system 1 performs wireless power transmission from a supply facility 2 to a vehicle 3 by magnetic resonance coupling (magnetic field resonance). A wireless power transfer system 1 transmits power from a supply facility 2 to a vehicle 3 running on a road 4 in a contactless manner. In other words, the wireless power transfer system 1 transmits power by a magnetic resonance method, and realizes power feeding to the vehicle 3 while the vehicle 3 is running by using magnetic resonance coupling (magnetic resonance). The wireless power transfer system 1 can be expressed as a dynamic wireless power transmission (D-WPT) system or a magnetic field dynamic wireless power transmission (MF-D-WPT) system.

The supply facility 2 includes a supply device 5 that is a road-side power supply device and an AC power supply 6 that supplies power to the supply device 5. The supply device 5 transmits power supplied from the AC power supply 6 to the vehicle 3 in a contactless manner. The AC power supply 6 is, for example, a commercial power supply. This supply device 5 comprises a power transmission device 10 having a primary coil 11.

The supply device 5 includes a segment 7 including the primary coil 11 and a management device 8 that manages the segment 7. Segment 7 is embedded within the lane of road 4. A management device 8 is installed on the side of the road 4. Segment 7 is electrically connected to management device 8. The management device 8 is electrically connected to the AC power supply 6 and supplies power from the AC power supply 6 to the segment 7. Segment 7 is electrically connected to AC power supply 6 via management device 8. A plurality of segments 7 can be arranged along the lanes of the road 4. For example, as shown in FIG. 1, the supply device 5 includes three segments 7 arranged side by side along the lane on the road 4 and one management device 8 to which the three segments 7 are connected. The segment 7 has the function of contactlessly transmitting power from the supply device 5 to the vehicle 3. Management device 8 has the function of controlling wireless power transmission in segment 7.

The vehicle 3 includes a power receiving device 20 that is a vehicle-side power receiving device having a secondary coil 21. The power receiving device 20 is provided on the bottom of the vehicle body of the vehicle 3. When the vehicle 3 travels on the road 4 on which the primary coil 11 is installed, the ground-side primary coil 11 and the vehicle-side secondary coil 21 vertically face each other. The wireless power transfer system 1 wirelessly transmits power from the primary coil 11 of the power transmission device 10 to the secondary coil 21 of the power receiving device 20 while the vehicle 3 is running on the road 4.

The term “running” in this description means that the vehicle 3 is positioned on the road 4 for running. A state in which the vehicle 3 is temporarily stopped on the road 4 is also included during traveling. For example, a state in which the vehicle 3 is stopped on the road 4 due to waiting for a traffic light, etc., is also included in running. On the other hand, even if the vehicle 3 is located on the road 4, for example, if the vehicle 3 is parked or stopped, it is not included in the running state.

Also, in this description, the lane in which the primary coil 11 (segment 7) is embedded is described as a D-WPT lane, and it is a partial section of the road 4 where wireless power transmission by the supply device 5 is possible. This may be referred to as a D-WPT charging site. In the D-WPT lane and the D-WPT charging site, a plurality of primary coils 11 (plurality of segments 7) are arranged in the traveling direction of the vehicle 3 over a predetermined section of the road 4.

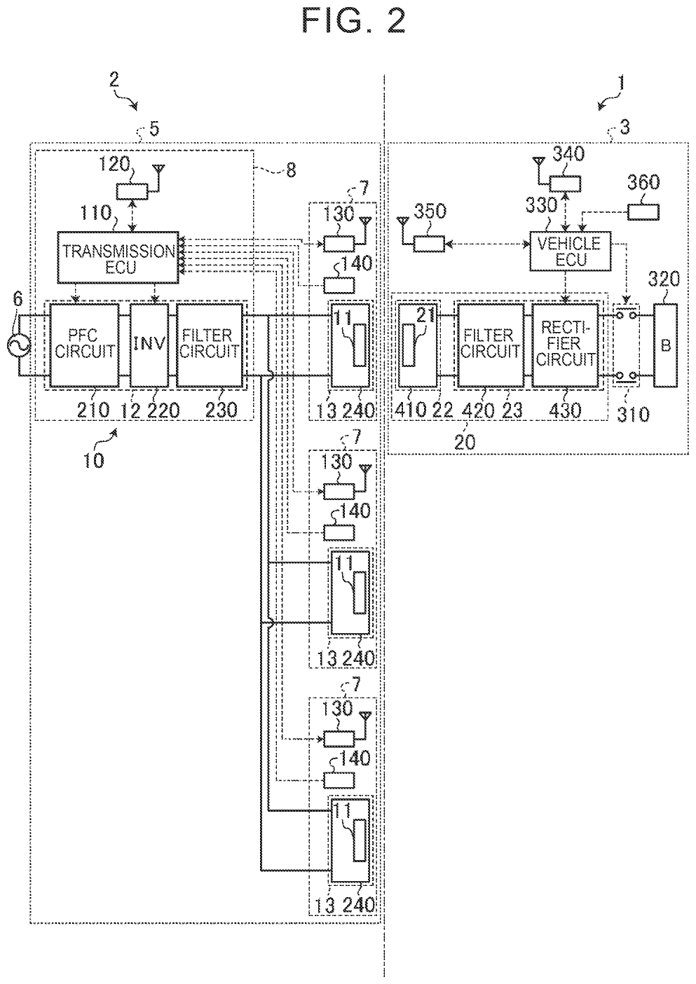

FIG. 2 is a diagram showing the overall configuration of the wireless power transfer system 1. In the supply facility 2, a supply device 5 and an AC power supply 6 are electrically connected. In supply device 5, segment 7 and management device 8 are electrically connected.

The supply device 5 includes a configuration provided in the management device 8 and a configuration provided in the segment 7. The supply device 5 includes a power transmission device 10, a power transmission Electronic Control Unit 110 (ECU), a first communication device 120, a second communication device 130 and a foreign object detection device 140.

Power transmission device 10 includes an electrical circuit connected to AC power source 6. The power transmission device 10 includes a power factor collection (PFC) circuit 210, an inverter (INV) 220, a filter circuit 230 and a power transmission side resonance circuit 240.

PFC circuit 210 improves the power factor of AC power input from AC power supply 6, converts the AC power into DC power, and outputs the DC power to inverter 220. This PFC circuit 210 is configured including an AC/DC converter. PFC circuit 210 is electrically connected to AC power supply 6.

Inverter 220 converts the DC power input from PFC circuit 210 into AC power. Each switching element of inverter 220 is configured by an Insulated Gate Bipolar Transistor (IGBT), a Metal-Oxide-Semiconductor Field Effect Transistor (MOSFET), or the like, and performs a switching operation according to a control signal from power transmission ECU 110. For example, the driving frequency of inverter 220 is 85 kHz. Inverter 220 outputs the converted AC power to filter circuit 230.

The filter circuit 230 removes noise contained in the alternating current input from the inverter 220 and supplies the noise-removed alternating current power to the power transmission side resonance circuit 240. Filter circuit 230 is an LC filter that combines a coil and a capacitor. For example, the filter circuit 230 is composed of a T-type filter in which two coils and one capacitor are arranged in a T-shape. PFC circuit 210, inverter 220, and filter circuit 230 configure power conversion unit 12 of power transmission device 10.

The power transmission side resonance circuit 240 is a power transmission unit that transmits the AC power supplied from the filter circuit 230 to the power receiving device 20 in a non-contact manner. When AC power is supplied from the filter circuit 230 to the power transmission side resonance circuit 240, a current flows through the primary coil 11 and a magnetic field for power transmission is generated.

The power transmission side resonance circuit 240 includes a primary coil 11 and a resonance capacitor. The primary coil 11 is a power transmission coil. This resonance capacitor is connected in series to one end of the primary coil 11 and adjusts the resonance frequency of the power transmission side resonance circuit. This resonant frequency is between 10 kHz and 100 GHz, preferably 85 kHz. For example, the power transmission device 10 is configured such that the resonance frequency of the power transmission side resonance circuit 240 and the drive frequency of the inverter 220 match. The power transmission side resonance circuit 240 constitutes the primary device 13 of the power transmission device 10.

The power transmission device 10 includes a power conversion unit 12 and a primary device 13. Power conversion unit 12 includes a PFC circuit 210, an inverter 220 and a filter circuit 230. The primary device 13 includes a power transmission side resonance circuit 240. The power transmission device 10 has a configuration in which a power conversion unit 12 is provided in the management device 8 and a primary device 13 is provided in the segment 7.

In the supply device 5, the power conversion unit 12 of the power transmission device 10, the power transmission ECU 110, and the first communication device 120 are provided in the management device 8, and the primary device 13 of the power transmission device 10 and the second communication device 130, and a foreign object detection device 140 are provided in the segment 7.

The power transmission ECU 110 is an electronic control device that controls the supply device 5. Power transmission ECU 110 includes a processor and a memory. A processor consists of a Central Processing Unit (CPU), a Digital Signal Processor (DSP), a Field-Programmable Gate Array (FPGA), and the like. The memory is a main storage device and consists of Random Access Memory (RAM), Read Only Memory (ROM), and the like. The power transmission ECU 110 loads a program stored in a storage unit into a work area of a memory (main storage device) and executes it, and controls each component through the execution of the program, so that a function that meets a predetermined purpose is realized. The storage unit is composed of recording media such as Erasable Programmable ROM (EPROM), Hard Disk Drive (HDD), and removable media. Removable media include disk recording media such as Universal Serial Bus (USB) memory, Compact Disc (CD), Digital Versatile Disc (DVD), and Blu-ray (Trademark) Disc (BD). The storage unit can store an operating system (OS), various programs, various tables, various databases, and the like. Signals from various sensors are input to power transmission ECU 110. A signal from foreign object detection device 140 is input to power transmission ECU 110. Power transmission ECU 110 then executes various controls based on signals input from various sensors.

For example, power transmission ECU 110 executes power control to adjust power for transmission. In this power control, the power transmission ECU 110 controls the power transmission device 10. Power transmission ECU 110 outputs a control signal to power conversion unit 12 in order to control power supplied from power conversion unit 12 to primary device 13. Power transmission ECU 110 controls switching elements included in PFC circuit 210 to adjust power for transmission, and controls switching elements included in inverter 220 to adjust power for transmission.

Power transmission ECU 110 also executes communication control for controlling communication with vehicle 3. In communication control, power transmission ECU 110 controls first communication device 120 and second communication device 130.

The first communication device 120 is a ground-side communication device that performs wide-area wireless communication. The first communication device 120 performs wireless communication with a vehicle 3 in a state before approaching the D-WPT lane among the vehicles 3 that are traveling on the road 4. The state before approaching the D-WPT lane means that the vehicle 3 is in a position where short-range wireless communication with the supply device 5 cannot be performed.

Wide-area wireless communication is communication with a communication distance of 10 meters to 10 kilometers. Wide-area wireless communication is communication with a longer communication distance than narrow-area wireless communication. Various types of wireless communication with long communication distances can be used as wide-area wireless communication. For example, communication conforming to communication standards such as 4G, LTE, 5G, and WiMAX established by 3GPP (registered trademark) and IEEE is used for wide area wireless communication. In the wireless power transfer system 1, vehicle information associated with vehicle identification information (vehicle ID) is transmitted from the vehicle 3 to the supply device 5 using wide area wireless communication.

The second communication device 130 is a communication device on the ground side that performs short-range wireless communication. The second communication device 130 wirelessly communicates with a vehicle 3 that has approached or entered the D-WPT lane among the vehicles 3 running on the road 4. A state in which the vehicle 3 is close to the D-WPT lane means that the vehicle 3 is in a position where short-range wireless communication can be performed with the supply device 5.

Short-range wireless communication is communication with a communication range of less than 10 meters. Short-range wireless communication is communication with a shorter communication distance than wide-area wireless communication. Various short-range wireless communications with short communication distances can be used as short-range wireless communications. For example, short-range wireless communication uses communication conforming to any communication standard established by IEEE, ISO, IEC, or the like. As an example, Wi-Fi (registered trademark), Bluetooth (registered trademark), ZigBee (registered trademark), etc. are used for short-range wireless communication. Alternatively, Radio Frequency Identification (RFID), Dedicated Short Range Communication (DSRC), or the like may be used as a technique for performing short-range wireless communication. In the wireless power transfer system 1, vehicle identification information and the like are transmitted from the vehicle 3 to the supply device 5 using short-range wireless communication.

A foreign object detection device 140 detects a metallic foreign object, a living body, or the like existing above the primary coil 11. The foreign object detection device 140 is composed of, for example, a sensor coil and an imaging device installed on the ground. The foreign object detection device 140 is for achieving Foreign Object Detection (FOD) and Living Object Protection (LOP) in the wireless power transfer system 1.

In the supply device 5, the configuration of the power transmission device 10 is divided into a segment 7 and a management device 8, and the three segments 7 are connected to one management device 8. The power transmission device 10 is configured such that one inverter supplies power to three power transmission side resonance circuits 240. In the supply device 5, signals from each segment 7 are input to the management device 8. Signals from second communication device 130 and foreign object detection device 14 provided in the first segment are input to power transmission ECU 110. Similarly, signals from second communication device 130 and foreign object detection device 14 provided in the second segment are input to power transmission ECU 110. Signals from second communication device 130 and foreign object detection device 14 provided in the third segment are input to power transmission ECU 110. Power transmission ECU 110 can grasp the state of each segment 7 based on the signal input from each segment 7.

Vehicle 3 includes power receiving device 20, charging relay 310, battery 320, vehicle ECU 330, third communication device 340, fourth communication device 350, and Global Positioning System (GPS) receiver 360.

The power receiving device 20 supplies the power received from the power transmission device 10 to the battery 320, which is a power storage device. Power receiving device 20 is electrically connected to battery 320 via charging relay 310. The power receiving device 20 includes a power reception side resonance circuit 410, a filter circuit 420, and a rectifier circuit 430.

The power reception side resonance circuit 410 is a power receiving unit that receives power wirelessly transmitted from the power transmission device 10. The power reception side resonance circuit 410 is configured by a power reception side resonance circuit including a secondary coil 21 and a resonance capacitor. The secondary coil 21 is a power receiving coil that receives power transmitted from the primary coil 11 in a non-contact manner. This resonance capacitor is connected in series to one end of the secondary coil 21 and adjusts the resonance frequency of the power reception side resonance circuit. The resonance frequency of power reception side resonance circuit 410 is determined to match the resonance frequency of power transmission side resonance circuit 240.

The resonance frequency of the power reception side resonance circuit 410 is the same as the resonance frequency of the power transmission side resonance circuit 240. Therefore, when a magnetic field is generated by the power transmission side resonance circuit 240 while the power reception side resonance circuit 410 faces the power transmission side resonance circuit 240, the vibration of the magnetic field is transmitted to the power reception side resonance circuit 410. The primary coil 11 and the secondary coil 21 will be in a resonance state. When an induced current flows through the secondary coil 21 due to electromagnetic induction, an induced electromotive force is generated in the power reception side resonance circuit 410. In this way, the power reception side resonance circuit 410 receives the power transmitted from the power transmission side resonance circuit 240 in a contactless manner. Then, the power reception side resonance circuit 410 supplies the power received from the power transmission side resonance circuit 240 to the filter circuit 420. The power reception side resonance circuit 410 constitutes the secondary device 22 of the power receiving device 20.

The filter circuit 420 removes noise contained in the AC current input from the power reception side resonance circuit 410 and outputs the noise-free AC power to the rectifier circuit 430. Filter circuit 420 is an LC filter that combines a coil and a capacitor. For example, the filter circuit 420 is configured by a T-type filter in which two coils and one capacitor are arranged in a T-shape.

Rectifier circuit 430 converts the AC power input from filter circuit 420 into DC power and outputs the DC power to battery 320. The rectifier circuit 430 is configured by, for example, a full bridge circuit in which four diodes are connected as rectifier elements in a full bridge. A switching element is connected in parallel to each diode of the rectifier circuit 430. Each switching element of rectifier circuit 430 is configured by an IGBT, and performs a switching operation according to a control signal from vehicle ECU 330. Rectifier circuit 430 supplies the converted DC power to battery 320. Filter circuit 420 and rectifier circuit 430 configure power conversion section 23 of power receiving device 20.

The power receiving device 20 includes a secondary device 22 and a power converter 23. The secondary device 22 includes a power reception side resonance circuit 410. Power conversion unit 23 includes a filter circuit 420 and a rectifier circuit 430.

Charging relay 310 is provided between rectifier circuit 430 and battery 320. Charging relay 310 is controlled to be opened or closed by vehicle ECU 330. When battery 320 is charged by power transmission device 10, charge relay 310 is controlled to be closed. When charging relay 310 is closed, rectifier circuit 430 and battery 320 are electrically connected. When charging relay 310 is open, the connection between rectifier circuit 430 and battery 320 is cut off so as not to be electrically conductive. For example, when charging relay 310 is in an open state, vehicle 3 does not request power supply.

The battery 320 is a rechargeable DC power supply, and is composed of, for example, a lithium ion battery, a nickel metal hydride battery, or the like. Battery 320 stores power supplied from power transmission device 10 to power receiving device 20. Also, the battery 320 can supply electric power to the driving motor of the vehicle 3. The battery 320 is electrically connected to the traction motor via a Power Control Unit (PCU). The PCU is a power conversion device that converts the DC power of the battery 320 into AC power and supplies it to the driving motor. Each switching element of the PCU is composed of an IGBT and performs a switching operation according to a control signal from the vehicle ECU 330.

Vehicle ECU 330 is an electronic control device that controls vehicle 3. Vehicle ECU 330 has the same hardware configuration as power transmission ECU 110. Signals from various sensors mounted on the vehicle 3 are input to the vehicle ECU 330. A positioning signal received by a GPS receiver 360 is also input to the vehicle ECU 330. Vehicle ECU 330 can acquire current position information of vehicle 3 from GPS receiver 360. Vehicle ECU 330 then executes various controls based on signals input from various sensors.

For example, vehicle ECU 330 performs contactless charging control in which power is transmitted from primary coil 11 to secondary coil 21 in a contactless manner and the power received by secondary coil 21 is stored in battery 320. In contactless charging control, vehicle ECU 330 controls rectifier circuit 430, charging relay 310, third communication device 340 and fourth communication device 350. The non-contact charging control includes power control for controlling charging power and communication control for controlling communication with the supply device 5. In power control, vehicle ECU 330 controls switching elements included in rectifier circuit 430 to adjust power (charging power) supplied from power receiving device 20 to battery 320. In communication control, vehicle ECU 330 controls third communication device 340 and fourth communication device 350.

The third communication device 340 is a vehicle-side communication device that performs wide-area wireless communication. The third communication device 340 wirelessly communicates with the first communication device 120 of the supply device 5 before the vehicle 3 traveling on the road 4 approaches the D-WPT lane. Wide area wireless communication is two-way wireless communication. Communication between the first communication device 120 and the third communication device 340 is performed by high-speed wireless communication.

The fourth communication device 350 is a vehicle-side communication device that performs short-range wireless communication. The fourth communication device 350 wirelessly communicates with the second communication device 130 of the supply device 5 when the vehicle 3 approaches or enters the D-WPT lane. Short-range wireless communication is unidirectional wireless signaling. Unidirectional wireless signaling is Point to point signaling (P2PS). P2PS is used for notifying vehicle identification information from the vehicle 3 to the supply device 5 in each activity of pairing, alignment check, magnetic coupling check, end of power transfer, and end of power transfer. P2PS can also be used as a means of lateral alignment check. The lateral direction is the width direction of the lane, and the width direction of the vehicle 3.

GPS receiver 360 detects the current position of vehicle 3 based on positioning information obtained from a plurality of positioning satellites. Current position information of vehicle 3 detected by GPS receiver 360 is transmitted to vehicle ECU 330.

Note that the filter circuit 230 in the supply device 5 may be included in the management device 8 instead of the segment 7. That is, the filter circuit 230 may be installed on the side of the road 4. In this case, the power conversion unit 12 includes a PFC circuit 210, an inverter 220 and a filter circuit 230, and the primary device 13 includes a power transmission side resonance circuit 240.

Further, the filter circuit 230 may be provided individually for each primary coil 11 or may be provided collectively for a plurality of primary coils 11.

Moreover, the filter circuit 230 is not limited to a T-type filter, and may be, for example, a band-pass filter in which a coil and a capacitor are connected in series. This is the same for the filter circuit 420 of the vehicle 3 as well.

Further, in the power transmission device 10, when the inverter 220 is connected to the plurality of primary coils 11, each primary device 13 may be provided with a switch for switching the primary coil 11 to be energized. This changeover switch may be provided in the management device 8 beside the road 4 or may be provided near the primary coil 11.

Moreover, the power transmission side resonance circuit 240 is not limited to the configuration in which the primary coil 11 and the resonance capacitor are connected in series. The primary coil 11 and resonant capacitor may be connected in parallel, or may be a combination of parallel and series. In short, the power transmission side resonance circuit 240 only needs to be configured such that the resonance frequency of the power transmission side resonance circuit 240 matches the driving frequency of the inverter 220, and the connection relationship of the components is not particularly limited. The same applies to the power reception side resonance circuit 410 of the vehicle 3.

Further, the driving frequency of inverter 220 is not limited to 85 kHz, and may be a frequency around 85 kHz. In short, the driving frequency of inverter 220 may be a predetermined frequency band including 85 kHz.

Further, the power transmission device 10 may have a configuration in which a plurality of inverters 220 are connected to the output side power line (DC power line) of the PFC circuit 210.

Moreover, the foreign object detection device 140 may be provided not only on the ground side but also on the vehicle 3 side. For example, when a foreign object detection device on the side of the vehicle 3 detects a foreign object or a living body existing above the primary coil 11, the power supply request can be stopped until the vehicle 3 passes the primary coil 11.

In the wireless power transfer system 1, information transmitted from the vehicle 3 to the supply device 5 using short-range wireless communication includes vehicle identification information, a power supply request, a power supply request value, and the like. A power supply request is information indicating a request for power transmission from the primary coil 11. The power supply request value is a request value for the amount of power transmitted from the supply device 5 to the vehicle 3. Vehicle ECU 330 can calculate the power supply request value based on the state of charge (SOC) of battery 320.

Moreover, the wireless power transfer system 1 is not limited to the method of supplying power from the ground to the vehicle 3, and can realize the method of supplying power from the vehicle 3 to the ground. In this case, the rectifier circuit 430 can be replaced with an inverter to achieve rectification during power supply and power reception.

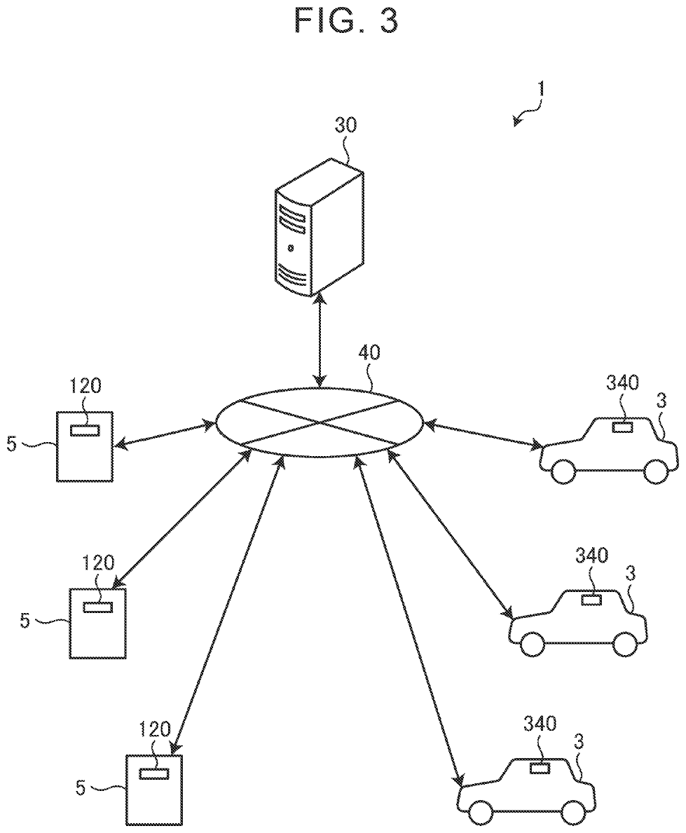

FIG. 3 is a schematic diagram for explaining wide-area wireless communication in the wireless power transfer system 1.

In the wireless power transfer system 1, the vehicle 3 can communicate with the server 30 and the supply device 5 can communicate with the server 30. The server 30 is connected to a network 40 and can communicate with multiple vehicles 3 and multiple supply devices 5 via the network 40. The network 40 is configured by a Wide Area Network (WAN), which is a public communication network such as the Internet, a telephone communication network for mobile phones, and the like.

The vehicle 3 connects to the network 40 through wide area wireless communication using the third communication device 340. Vehicle 3 transmits information to server 30 and receives information from server 30.

The supply device 5 connects to the network 40 by wide area wireless communication using the first communication device 120. The supply device 5 transmits information to the server 30 and receives information from the server 30.

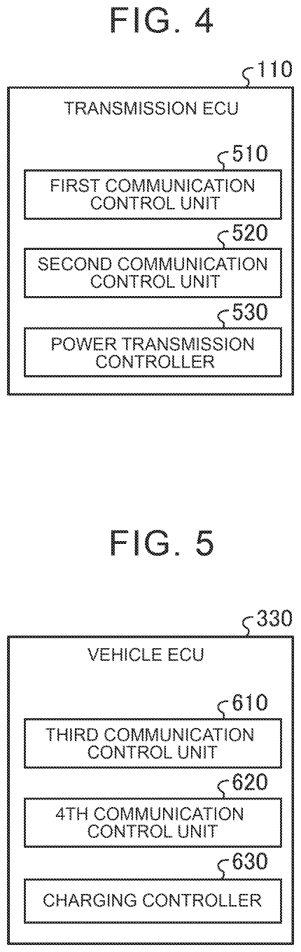

FIG. 4 is a block diagram showing a functional configuration of power transmission ECU 110. Power transmission ECU 110 includes first communication control unit 510, second communication control unit 520, and power transmission control unit 530.

The first communication control unit 510 executes first communication control for controlling the first communication device 120. The first communication control controls wide-area wireless communication on the supply device 5 side, and controls communication of the supply device 5 using the first communication device 120. That is, the first communication control controls communication of the management device 8 of the supply device 5. The first communication control controls communication between the supply device 5 and the network 40 and controls communication between the supply device 5 and the server 30 via the network 40. The first communication control unit 510 is a Supply Equipment Communication Controller (SECC).

The second communication control unit 520 executes second communication control for controlling the second communication device 130. The second communication control controls short-range wireless communication on the supply device 5 side, and controls communication of the supply device 5 using the second communication device 130. That is, the second communication control controls communication of the segment 7 of the supply device 5. The second communication control controls communication between the supply device 5 and the vehicle 3 as communication not via the network 40. The second communication control unit 520 is a Primary Device Communication Controller (PDCC).

The power transmission control unit 530 executes power transmission control for controlling the power transmission device 10. Power transmission control controls power for transmission, and controls the power conversion unit 12 of the power transmission device 10. Power transmission control unit 530 performs power control to control PFC circuit 210 and inverter 220.

FIG. 5 is a block diagram showing the functional configuration of vehicle ECU 330. Vehicle ECU 330 includes a third communication control unit 610, a fourth communication control unit 620, and a charging control unit 630.

The third communication control unit 610 executes third communication control for controlling the third communication device 340. The third communication control controls wide-area wireless communication on the vehicle 3 side, and controls communication of the vehicle 3 using the third communication device 340. The third communication control controls communication between the vehicle 3 and the network 40 and controls communication between the vehicle 3 and the server 30 via the network 40. The third communication control unit 610 is an EV Communication Controller (EVCC).

The fourth communication control unit 620 executes fourth communication control for controlling the fourth communication device 350. The fourth communication control controls short-range wireless communication on the vehicle 3 side, and controls communication of the vehicle 3 using the fourth communication device 350. The fourth communication control controls communication between the vehicle 3 and the supply device 5 as communication not via the network 40. The fourth communication control unit 620 is a Secondary Device Communication Controller (SDCC).

Charging control unit 630 executes charging control to control power receiving device 20 and charging relay 310. Charging control includes power control for controlling received power in power receiving device 20 and relay control for controlling the connection state between secondary device 22 and battery 320. Charging control unit 630 performs power control to control rectifier circuit 430. Charging control unit 630 performs relay control to switch the open/closed state of charging relay 310.

In the wireless power transfer system 1 configured as described above, wireless power transmission from the supply device 5 to the vehicle 3 is performed in a state where wireless communication is established between the vehicle 3 and the supply device 5. In a state in which the vehicle 3 and the supply device 5 are paired by wireless communication, power is transmitted from the primary coil 11 on the ground side to the secondary coil 21 on the vehicle side in a non-contact manner. Then, in the vehicle 3, charging control is performed to supply the electric power received by the secondary coil 21 to the battery 320.

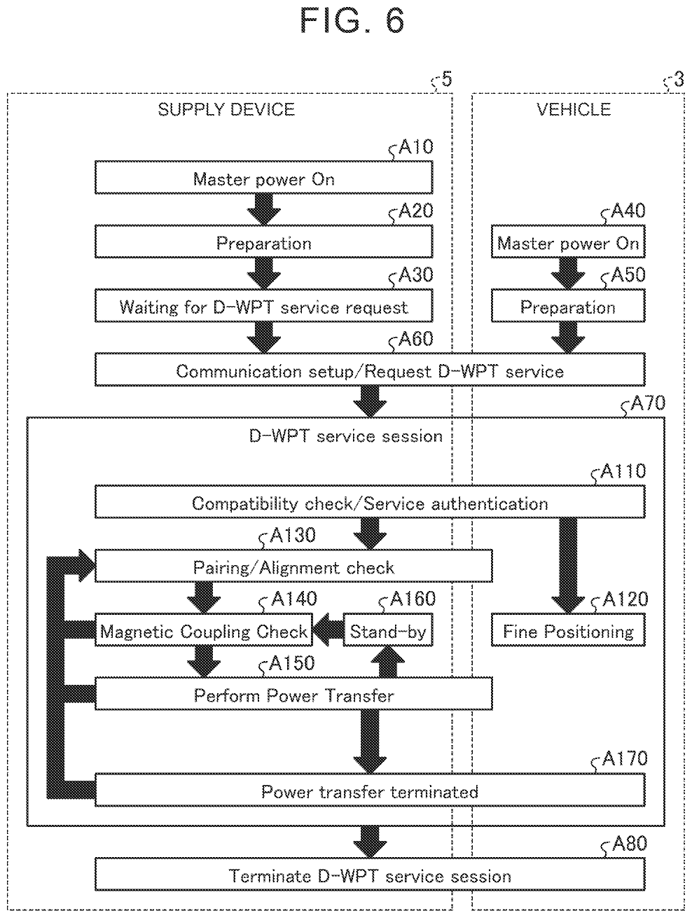

Next, the power transmission process (D-WPT process) will be described with reference to FIG. 6. The power transfer process is structured as a chain of activities, a process derived from states and corresponding transitions.

FIG. 6 is a diagram for explaining the power transmission process. FIG. 6 shows basic activities to explain the power transfer process. The thick arrows shown in FIG. 6 represent transition lines. The state of the wireless power transfer system 1 in the power transfer process is represented by the activities that make up the power transfer process.

The activities that make up the power transmission process are a power transmission service session (D-WPT service session A70) that is an activity in the stage of power transmission, an activity before power transmission, and an activity after power transmission. Further, the activity can be explained by dividing the subject of action according to the presence or absence of communication between the supply device 5 and the vehicle 3. Activities are divided into the following: an activity representing the state of only the supply device 5 side without communication, an activity representing the state of only the vehicle 3 side without communication, and an activity representing the state of both the supply device 5 and the vehicle 3 with communication.

As shown in FIG. 6, the activities include: Master power ON A10, Preparation A20, Waiting for D-WPT service request A30 from the vehicle 3, and Master power On A40, Preparation A50, Communication setup and Request D-WPT service A60, D-WPT service session A70 and Terminate D-WPT service session A80.

Preparation A20 is the preparation state of the supply device 5. In preparation A20, the supply device 5 performs circuit activation and safety confirmation without communication with the vehicle 3. The supply device 5 transitions to the preparation A20 state when the master power supply is turned on A10. Then, in preparation A20, when the supply device 5 activates the circuit and confirms safety, the state transitions to waiting for a request from the vehicle 3 A30. On the other hand, if there is a problem with the supply device 5, the supply device 5 notifies the vehicle 3 of information (unavailability notification) indicating that the wireless power transfer system 1 cannot be used through wide area wireless communication. The first communication device 120 transmits a usage prohibition notice to the vehicle 3.

Preparation A50 is the preparation state of the vehicle 3. In preparation A50, the vehicle 3 performs circuit activation and safety confirmation without communication with the supply device 5. The vehicle 3 transitions to the state of preparation A50 when the master power supply is turned on A40. Then, in the preparation A50, when the vehicle 3 activates the circuit and confirms safety, the state transitions to the communication setting and D-WPT service request A60. On the other hand, if there is a problem with vehicle 3, vehicle 3 will not initiate wide area wireless communication and will not proceed with subsequent sequences in the D-WPT process.

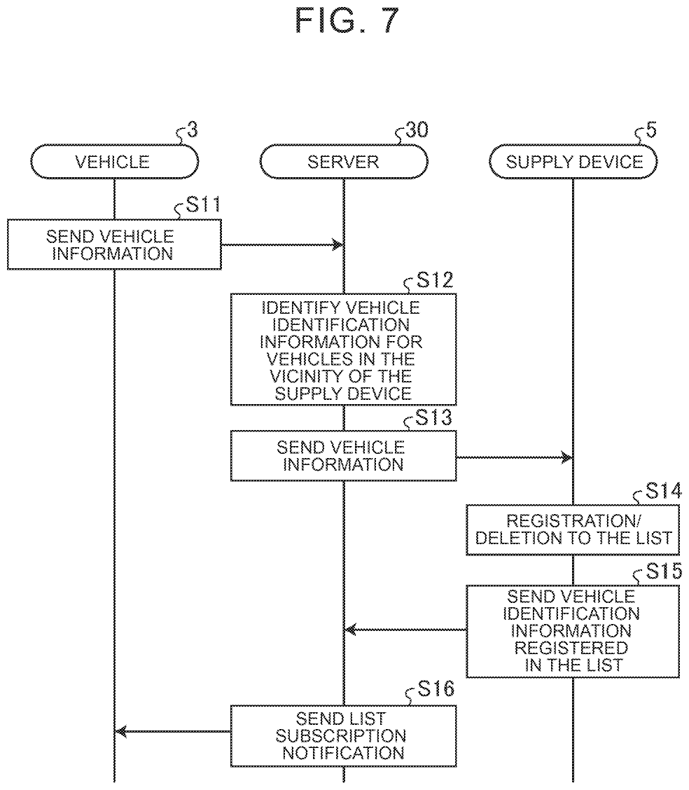

Request A60 for communication setup and D-WPT service is initiated by vehicle ECU 330. In communication setup and D-WPT service request A60, vehicle ECU 330 initiates wide area wireless communication. First, when the vehicle 3 transitions from preparation A50 to communication setup and D-WPT service request A60, the third communication device 340 transmits a D-WPT service request signal. The third communication device 340 wirelessly communicates with the first communication device 120 corresponding to the D-WPT lane that the vehicle 3 is planning to enter or has entered. The first communication device 120 to communicate with is selected based on the relative positional relationship between the current position of the vehicle 3 and the position of the D-WPT lane. On the supply device 5 side, when the first communication device 120 receives the D-WPT service request signal in the state of waiting for a request from the vehicle 3 A30, the state transitions to the communication setting and D-WPT service request A60. Various types of information in wide area wireless communication and P2PS communication are linked using vehicle identification information. FIG. 7 shows the processing sequence of this communication setup and D-WPT service request A60.

FIG. 7 is a sequence diagram showing a case where communication using wide area wireless communication is performed between the vehicle 3 and the supply device 5. The vehicle 3 transmits vehicle information to the server 30 (S11). In S11, the third communication device 340 of the vehicle 3 transmits vehicle information to the server 30. The vehicle information includes vehicle identification information, various parameters of the power receiving device 20, current position information of the vehicle 3, and requested power. Vehicle ECU 330 calculates the required electric power based on the SOC of battery 320. In S11, the vehicle ECU 330 causes the third communication device 340 to transmit vehicle information at predetermined time intervals. The predetermined time is set according to the distance from the current position of the vehicle 3 to the starting point of the D-WPT lane. The shorter the distance from the vehicle 3 to the starting point of the D-WPT lane, the shorter the predetermined time interval.

When the server 30 receives the vehicle information from the vehicle 3, the server 30 specifies the vehicle identification information of the vehicle 3 located within the vicinity area of the supply device 5 based on the current position information of the vehicle 3 included in the vehicle information (S12). In S12, the server 30 identifies the vehicle 3 positioned within a predetermined vicinity area from the supply device 5 based on the current position information of the vehicle 3 and the position information of the supply device 5. The neighboring area is set within 500 meters, for example.

After specifying the vehicle identification information of the vehicle 3, the server 30 transmits the vehicle information to the supply device 5 (S13). At S13, the transmission device of the server 30 transmits vehicle information to the supply device 5.

When the supply device 5 receives the vehicle information from the server 30, the supply device 5 registers/deletes the vehicle identification information in the identification information list (S14). In S14, the power transmission ECU 110 registers/deletes the vehicle identification information in the identification information list so that the vehicle identification information linked to the vehicle information is registered in the identification information list without excess or deficiency.

After registering/erasing the vehicle identification information in the identification information list, the supply device 5 transmits the vehicle identification information registered in the identification information list to the server 30 (S15). At S15, the first communication device 120 of the supply device 5 transmits the vehicle identification information to the server 30.

When the server 30 receives the vehicle identification information from the supply device 5, the server 30 transmits a list registration notification to the vehicle 3 corresponding to the vehicle identification information registered in the identification information list (S16). In S16, the communication device of server 30 transmits a list registration notification to vehicle 3. The list registration notification is a notification indicating that the vehicle identification information is registered in the identification information list, and includes identification information of the supply device 5 and position information of the supply device 5.

In this way, when the vehicle 3 starts wide-area wireless communication and both the supply device 5 and the vehicle 3 are in the state of communication setting and D-WPT service request A60, it means that communication setting by wide-area wireless communication has succeeded. When this communication setup succeeds, the state transitions to D-WPT service session A70.

Return to FIG. 6. In a state where the communication connection is established between the supply device 5 and the vehicle 3, the D-WPT service session A70 transmits power in a noncontact manner from the power transmission side resonance circuit 240 of the supply device 5 to the power reception side resonance circuit 410 of the vehicle 3. The D-WPT service session A70 begins with successful communication setup and ends with the termination of communication. When the communication ends in the state of D-WPT service session A70, the state transitions to Terminate D-WPT service session A80.

In Terminate D-WPT service session A80, the vehicle 3 terminates the wide area wireless communication with the supply device 5. The vehicle 3 and the supply device 5 can receive a trigger to terminate the D-WPT service session A70. Then, vehicle ECU 330 prevents D-WPT from being started for secondary device 22 and vehicle 3 until third communication device 340 receives the next notification (D-WPT service request signal).

The detailed activities of D-WPT service session A70 will now be described.

The D-WPT service session A70 consists of Compatibility check and Service authentication A110, Fine Positioning A120 in the lateral direction of the vehicle, Pairing and Alignment check A130, Magnetic Coupling Check A140, Perform Power Transfer A150, Stand-by A160, Power transfer terminated A170, including.

The compatibility check and service authentication A110 will be described. After successful communication setup, vehicle ECU 330 and power transmission ECU 110 confirm that primary device 13 and secondary device 22 are compatible. The compatibility check is performed on the supply device 5 side based on the information associated with the vehicle identification information acquired by communication. Check items include the minimum ground clearance of the secondary device 22, the shape type of the secondary device 22, the circuit topology of the secondary device 22, the self-resonant frequency of the secondary device 22, and the number of secondary coils 21.

In the compatibility check and service authentication A110, first, the vehicle 3 transmits compatibility information of the power receiving device 20 from the third communication device 340 to the supply device 5. The first communication device 120 of the supply device 5 receives the compatibility information of the power receiving device 20 from the vehicle 3. Then, the first communication device 120 of the supply device 5 transmits the compatibility information of the power transmission device 10 to the vehicle 3. The third communication device 340 of the vehicle 3 receives the compatibility information of the power transmission device 10 from the supply device 5.

Elements of the compatibility information that the vehicle 3 sends to the supply device 5 include vehicle identification information, WPT power classes, air gap class, WPT operating frequencies, WPT frequency adjustments, WPT type, WPT circuit topology, fine positioning method, pairing method, alignment method, and information of presence/absence of power adjustment function.

Elements of compatibility information that supply device 5 sends to vehicle 3 include feeder identification, WPT power class, gap class, WPT drive frequency, WPT frequency adjustment, WPT type, WPT circuit topology, detailed alignment method, A pairing method, an alignment method, information on the presence or absence of a power adjustment function, and the like are included.

Each element name is explained in detail. Each element of the compatibility information transmitted from the vehicle 3 to the supply device 5 will be described. Of the compatibility information transmitted from the supply device 5 to the vehicle 3, information that overlaps with the information transmitted from the vehicle 3 to the supply device 5 is omitted.

A gap class is information indicating a gap class that the secondary device 22 can receive power from. The WPT power class is information indicating the power class 5 that the secondary device 22 can receive. The WPT drive frequency is information indicating the frequency of received power received by the secondary device 22. The WPT frequency adjustment is information indicating whether or not the driving frequency can be adjusted. The WPT type is information indicating the shape type of the secondary device 22 and indicates the coil shape of the secondary coil 21. Examples of WTP types include circles and solenoids. The WPT circuit topology is information indicating the connection structure between the secondary coil 21 and the resonant capacitor. WTP circuit topologies include series and parallel. The detailed alignment method is information indicating how to perform alignment when performing alignment. The pairing method is a method of performing pairing by which the vehicle 3 identifies the supply device 5. The alignment method indicates a method of confirming the relative positions of the secondary device 22 and the primary device 13 before starting power transmission.

Fine positioning A120 in the vehicle lateral direction will be described. The vehicle 3 performs fine positioning A120 in the vehicle lateral direction prior to the pairing and alignment check A130 or in parallel with these activities. When the vehicle ECU 330 20 determines that the vehicle 3 has approached or entered the area (WPT lane) where the supply device 5 is installed, the vehicle ECU 330 starts fine positioning A120 in the lateral direction of the vehicle.

Vehicle ECU 330 guides vehicle 3 to align primary device 13 and secondary device 22 within a range that establishes sufficient magnetic coupling for wireless power transfer.

Fine positioning A120 in the lateral direction of the vehicle is basically performed manually or automatically on the vehicle 3 side. Fine positioning A120 in the lateral direction of the vehicle can be coordinated with Automatic Driving Assistance System (ADAS). This end of communication is Terminate D-WPT service session A80.

Then, the activity of fine positioning A120 in the vehicle lateral direction continues until the vehicle 3 leaves the D-WPT charging site or the state changes to end of communication, and can be performed based on the alignment information sent to the vehicle 3 from the supply device 5 by the wide-area wireless communication.

The pairing and alignment check A130 will now be described. Here, the pairing and alignment check will be described separately.

Explain pairing. A P2PS interface with short-range wireless communication ensures that the primary device 13 and the secondary device 22 are uniquely paired. The pairing state process is as follows.

First, vehicle ECU 330 recognizes that vehicle 3 has approached or entered the D-WPT lane. For example, the vehicle ECU 330 has map information including D-WPT lanes, compares it with the positional information of the own vehicle obtained by the GPS receiver 360, and recognizes approach or entry based on the linear distance. The vehicle 3 transmits which D-WPT lane it has approached to the server 30 by wide area wireless communication. In short, the third communication device 340 notifies the cloud of a signal indicating that the vehicle 3 has approached one of the D-WPT lanes. Further, when vehicle ECU 330 recognizes that vehicle 3 is approaching or entering the D-WPT lane, fourth communication device 350 modulates at regular intervals for pairing primary device 13 and secondary device 22. Start sending signals.

Further, the supply device 5 may recognize that the vehicle 3 has approached or entered the D-WPT lane using information obtained from the server 30 through wide area wireless communication. The server 30 assigns the vehicle identification information of the vehicle 3 approaching in each D-WPT lane to the supply device 5 corresponding to that lane. Since the supply device 5 only needs to refer to the vehicle identification information whose number has been narrowed down by the server 30, the authentication process can be performed in a short time. When the supply device 5 recognizes that the vehicle 3 is approaching the D-WPT lane, the second communication device 130 enters standby mode. In standby mode, it waits to receive a modulated signal from the fourth communication device 350 of the vehicle 3. This modulated signal contains vehicle identification information.

When the second communication device 130 receives the modulated signal from the vehicle 3, the supply device 5 performs wide-area wireless communication between the vehicle identification information received by the short-range wireless communication and the plurality of vehicles 3 approaching the D-WPT lane. The vehicle identification information in the identification information list obtained as a result of step 3 is compared with the vehicle identification information. By means of this comparison, supply device 5 identifies vehicle 3.

When vehicle ECU 330 recognizes that vehicle 3 is out of the D-WPT lane, vehicle ECU 330 stops transmission of the modulated signal from fourth communication device 350. Vehicle ECU 330 can determine whether the vehicle has passed through the D-WPT lane based on the map information and the position information of the host vehicle.

When the supply device 5 determines that the vehicle 3 is not traveling in the D-WPT lane or determines that the vehicle 3 is not approaching the D-WPT lane, the modulation signal from the fourth communication device 350 Stop waiting for traffic lights.

Pairing is performed to the primary device 13 until the vehicle 3 exits the D-WPT charging site or the state changes to end of communication. Once the pairing is complete, the state transitions to check alignment.

Alignment check will be explained. The alignment check is intended to ensure that the lateral distance between the primary device 13 and the secondary device 22 is within tolerance. The alignment check is done using short range wireless communication (P2PS).

Alignment checks continue to be performed on a P2PS basis until the vehicle 3 leaves the D-WPT charging site or the state changes to End of Communication. The results of the alignment check can be transmitted from the first communication device 120 to the third communication device 340 via wide area wireless communication.

The magnetic coupling check A140 will be explained. In the magnetic coupling check A140, the supply device 5 confirms the magnetic coupling state and confirms that the secondary device 22 exists within the allowable range. When the magnetic coupling check A140 ends, the state transitions to Perform Power Transfer A150.

Perform Power Transfer A150 will be described. In this state, the supply device 5 performs power transmission to the power receiving device 20. The power transmission device 10 and the power receiving device 20 need to have the ability to control the transmitted power (transmitted power and received power) for the usefulness of the MF-D-WPT and the protection of the power receiving device 20 and the battery 320. Greater power transfer helps power receiving device 20 travel longer distances without static wireless charging and conductive charging. However, the capacity of the battery 320 varies depending on the vehicle type of the vehicle 3, and the power demand for driving may fluctuate abruptly. This abrupt change includes abrupt regenerative braking. When the regenerative braking is performed while traveling in the D-WPT lane, the regenerative braking is given priority. Therefore, in addition to regenerative power, received power from the power receiving device 20 is supplied to the battery 320. In this case, in order to protect the battery 320 from overcharging, it is necessary to adjust the transmission power by the power receiving device 20.

Despite the need for power control, no new communication is initiated between the supply device 5 and the power receiving device 20 in this state. This is because communication can impair responsiveness and accuracy in power control due to its instability and latency. Therefore, the supply device 5 and the power receiving device 20 perform power transmission and control based on known information up to this state.

The supply device 5 increases the transmission power for the magnetic coupling check in advance in response to the power request transmitted from the third communication device 340 using wide area wireless communication. The supply device 5 tries to keep the current and voltage fluctuations within its bounds while maximizing the power transferred during the transition.

The power receiving device 20 basically receives power transmitted from the power transmission device 10 without any control. However, the power receiving device 20 starts control when the transmitted power exceeds or is about to exceed the limit, such as the rated power of the battery 320 that fluctuates according to the state of charge and the power demand for driving the vehicle 3. Further, power control in vehicle ECU 330 is also required to cope with malfunctions in wide-area wireless communication. This malfunction leads to a contradiction between the power control target in the primary device 13 and the request from the third communication device 340, and a sudden failure of the power receiving device 20 or the battery 320 during power transmission. The power receiving device 20 controls the transmitted power under the power request rate notified by the first communication device 120.

Power requirements are determined based on vehicle 3 and primary device 13 WPT circuit topology, geometry, ground clearance, and compatibility check information such as EMC (electromagnetic compatibility). The magnetic field differs according to these specifications, and it is necessary to transmit power within a range that satisfies EMC.

Power control in power transmission ECU 110 and power receiving device 20 may interfere with each other. In particular, if the supply device 5 attempts to achieve a power demand greater than the current power limit at the power receiving device 20 via wide area wireless communication, it may interfere. An example of this is rapid regenerative control with a relatively small battery 320 in vehicle 3. If possible, it is desirable that the supply device 5 be able to detect mismatches between power control targets and limits and adjust power transfer to overcome the mismatches.

For example, if a foreign object on primary device 13 is detected by foreign object detection device 14, or if secondary device 22 is misaligned and the magnetic coupling is low, secondary device 22 is still above primary device 13. If power transfer is interrupted for a short period while in Stand-by A160, the state transitions to Stand-by A160. In addition, when the vehicle 3 is provided with a foreign object detection device, the foreign object may be detected on the vehicle 3 side.

When the secondary device 22 passes over the primary device 13, the state transitions to End Power Transfer A170. In this case, less power is transferred because the magnetic coupling between the two devices is weaker. Since the supply device 5 can detect that the magnetic coupling has weakened by monitoring the transmitted power, the supply device 5 basically determines the state transition to the end of power transmission A170, and then the power Start dropping voltage to stop transmission.

The Stand-by A160 will be explained. In this state the power transfer is briefly interrupted for some reason and when the D-WPT is ready in both the vehicle 3 and the supply device 5 the state returns to Perform Power Transfer A150. If the power transfer can be interrupted, the state becomes Stand-by A160.

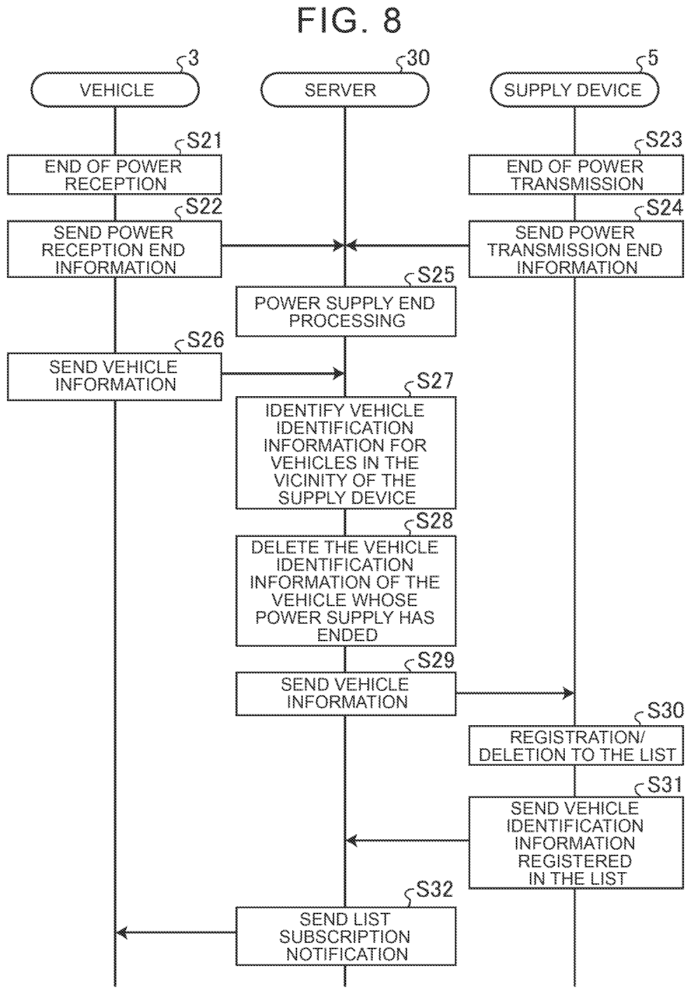

The end of power transmission A170 will be described. In this state, the supply device 5 reduces the transmitted power to zero and retains or uploads power transmission result data such as total transmitted power, power transmission efficiency, and failure history. Each data is tagged with vehicle identification information. Finally, the supply device 5 deletes the vehicle identification information of the vehicle 3 that has passed through the D-WPT lane. This allows the supply device 5 to be ready for subsequent pairing and power transfer to another vehicle. FIG. 8 shows the processing sequence of the end of power transmission A170.

FIG. 8 is a sequence diagram showing the operation after the supply device 5 supplies power to the vehicle 3 while the vehicle is running. When the power receiving device 20 of the vehicle 3 finishes receiving power from the supply device 5 (S21), the vehicle 3 transmits power receiving end information to the server 30 (S22). In S22, power reception end information is transmitted from the third communication device 340 of the vehicle 3. The power reception end information includes, as information related to power reception from the supply device 5, vehicle identification information of the vehicle 3, power received from the supply device 5, power reception efficiency, and an abnormality detection result, for example.

The supply device 5 ends power transmission to the vehicle 3 when the process of S21 is performed (S23). The processing of S21 and the processing of S23 may or may not be performed at the same time. When the process of S23 is performed, the supply device 5 transmits power transmission end information to the server 30 (S24). In S24, power transmission end information is transmitted from the first communication device 120 of the supply device 5.

When receiving the power reception end information from the vehicle 3 and the power transmission end information from the supply device 5, the server 30 performs power supply end processing for ending power supply from the supply device 5 to the vehicle 3 (S25). In the power supply end process, based on the power reception end information and the power transmission end information, a process of calculating the amount of power supplied from the supply device 5 to the vehicle 3 and a process of charging the user of the vehicle 3 based on the calculated amount of power supplied are performed.

In addition, the vehicle 3 transmits vehicle information to the server 30 regardless of the power supply termination process (S26). In S26, vehicle information is transmitted from the third communication device 340 of the vehicle 3.

When the server 30 receives the vehicle information from the vehicle 3 after performing the power supply termination process, the server 30 specifies the vehicle identification information of the vehicle 3 located within the vicinity area of each supply device 5 based on the vehicle information (S27).

Then, if a supply device 5 has already completed power feeding to a vehicle 3, the server 30 deletes the vehicle identification information of the vehicle 3 for which the power supply termination process has already been performed (S28) from the vehicle identification information of the vehicle 3 in the vicinity area of the supply device 5 specified in the process of S27.

After that, the server 30 sends the vehicle information associated with the vehicle identification information that has not been deleted in the process of S28 out of the vehicle identification information of the vehicle 3 specified to be located in the vicinity area of each supply device 5 to each supply device 5 (S29).

After the vehicle information is transmitted to each supply device 5 in the process of S29, when the supply device 5 receives the vehicle information from the server 30, the supply device 5 registers/deletes the vehicle identification information in the identification information list (S30). The processing of S30 is the same as the processing of Si4 in FIG. 7. After that, the supply device 5 transmits the vehicle identification information registered in the identification information list to the server 30 (S31). The processing of S31 is the same as the processing of S15 in FIG. 7.

When the server 30 receives the vehicle identification information from the supply device 5, the server 30 transmits a list registration notification to the vehicle 3 corresponding to the vehicle identification information registered in the identification information list (S32). The processing of S32 is the same as the processing of S16 in FIG. 7.

As a result, when the processing shown in FIG. 8 is performed, the identification information list indicates that each supply device 5 is located in the vicinity area, that the supply device 5 has not finished supplying power, and Vehicle identification information is registered for vehicles 3 for which no vehicle identification information deletion request has been made. Then, when the vehicle identification information of the vehicle 3 is registered in the identification information list of any of the supply facilities 2, the vehicle 3 receives the list registration notification. Therefore, the vehicle ECU 330 can determine that the own vehicle is registered in one of the supply devices 5 by receiving the list registration notification. When the vehicle 3 moves out of the vicinity area of the supply device 5, the vehicle identification information of the vehicle 3 is deleted from the identification information list of the supply device 5.

Return to FIG. 6. In addition, at the end of power transmission A170, the power receiving device 20 does not need to do anything to make the transmission power zero. The P2PS interface remains active when the vehicle 3 is in the D-WPT lane and the state of the power receiving device 20 automatically transitions to pairing for the next power transfer from the primary device 13. The state transitions from End Power Transfer A170 to Pairing and Alignment Check A130 as the transition line shown in FIG. 6. As shown in FIG. 6, when a predetermined transition condition is satisfied, the transition from the magnetic coupling check A140 to the pairing and alignment check A130, or the transition from Perform Power Transfer A150 to the pairing and alignment check A130 are possible. The pairing may be performed individually for the plurality of primary coils 11 or may be performed at a representative point by bundling the plurality of primary coils 11.

In the D-WPT service session A70, when there is no D-WPT request from the vehicle ECU 330, or a series of states from the communication setting and D-WPT service request A60 to the end of power transmission A170 are prohibited. In this case, the process transitions to Terminate D-WPT service session A80, and the wide area wireless communication between the first communication device 120 and the third communication device 340 is stopped. For example, the D-WPT shuts down when the state of charge in battery 320 is too high or when powered device 20 is too hot for continuous power transfer. Such unnecessary D-WPT can be disabled by simply deactivating the P2PS interface. However, by stopping the wide area wireless communication, the power transmission ECU 110 can release the memory occupied for the vehicle 3 without requiring the D-WPT by terminating the established wide area wireless communication.

Also, the D-WPT service session A70 is not limited to transitions such as the transition lines shown in FIG. 6. When the activities after the pairing and alignment check A130 are completed in the D-WPT service session A70 and conditions are met for the power transfer process to remain in the D-WPT service session A70, a transition to Terminate D-WPT service session A80 is not made but a transition to the compatibility check and service authentication A110 is made. For example, in the state of magnetic coupling check A140, if a predetermined transition condition is met, the state can transition to compatibility check and service authentication A110.

In the wireless power transfer system 1 according to the embodiment, the vehicle 3 can perform regenerative braking and charge the battery 320. In the wireless power transfer system 1 according to the embodiment, when the vehicle 3 approaches or enters the D-WPT lane, the primary device 13 of the supply device 5 is compatible with the secondary device 22 of the vehicle 3 (power receiving device 20) is satisfied and there is a possibility that the battery 320 is overcharged, predetermined charging control is performed by short-range wireless communication. On the other hand, the wireless power transfer system 1 according to the embodiment satisfies compatibility between the primary device 13 of the supply device 5 and the secondary device 22 of the vehicle 3 (power receiving device 20), and there is no possibility of overcharging the battery 320. In this case, the predetermined charging control by short-range wireless communication is not performed. As a result, the wireless power transfer system 1 according to the embodiment can suppress unnecessary short-range wireless communication while suppressing overcharging. Moreover, it is preferable to perform the predetermined charging control particularly in a compact car in which the capacity of the battery 320 is small and power adjustment is difficult.

In the wireless power transfer system 1 according to the embodiment, the vehicle ECU 330 of the vehicle 3 determines the maximum value of the power that can be transmitted by the supply device 5, the chargeable amount of the battery 320 of the vehicle 3, and the amount of power generated when the vehicle 3 brakes. Based on the maximum amount of power generated by the regenerative braking, it is determined whether there is a possibility that the battery 320 will be overcharged. For example, the vehicle ECU 330 defines Pw_max as the maximum amount of power that can be transmitted by the supply device 5, Pr_max as the maximum amount of power generated by regenerative braking that occurs during brake operation, and Win as the chargeable amount of the battery 320 of the vehicle 3. At this time, it is determined whether the relationship Win<Pw_max+Pr_max is satisfied. Note that the maximum value Pw_max of the amount of electric power generated by the regenerative braking is preferably variable according to the vehicle speed of the vehicle 3.

When the relationship Win<Pw_max+Pr_max is satisfied, vehicle ECU 330 determines that overcharging of battery 320 may occur due to the power from supply device 5 and the power from the regenerative braking. On the other hand, when vehicle ECU 330 determines that the relationship Win<Pw_max+Pr_max is not satisfied, vehicle ECU 330 determines that there is no possibility of overcharging of battery 320 due to the power from supply device 5 and the power from the regenerative braking. Vehicle ECU 330 prohibits regenerative braking of vehicle 3 when it determines that overcharging of battery 320 may occur. On the other hand, vehicle ECU 330 permits regenerative braking of vehicle 3 when determining that there is no possibility of overcharging of battery 320.

Whether the battery 320 may be overcharged is determined by a compatibility check performed between the vehicle 3 and the supply device 5 only when it is determined that the primary device 13 of the supply device 5 of the D-WPT lane in which the vehicle 3 approaches or enters is compatible with the secondary device 22 of the vehicle 3.

Then, when it is determined by the compatibility check that the vehicle ECU 330 is compatible and that there is a possibility that the battery 320 is overcharged, the vehicle ECU 330 may determine whether a power command can be issued by, for example, short-range wireless communication. Then, if the vehicle ECU 300 is capable of issuing a power command from the vehicle 3 to the supply device 5 through short-range wireless communication, the vehicle ECU 300 performs the predetermined charging control when there is a possibility that the battery 320 is overcharged. The regenerative braking of the vehicle 3 is permitted, and the regenerative braking of the vehicle 3 is prohibited if the power command cannot be issued from the vehicle 3 to the supply device 5 by short-range wireless communication.

Whether it is possible to issue a power command from the vehicle 3 to the supply device 5 by short-range wireless communication is determined in consideration of, for example, the amount of information that can be transmitted from the vehicle 3 to the supply device 5 by short-range wireless communication, and the communication time required for short-range wireless communication between the vehicle 3 and the supply device 5. That is, since the amount of information that can be transmitted by short-range wireless communication is small, if there is no space for the amount of information to transmit the power command due to information related to other vehicles 3 including vehicle identification information, short-range wireless communication is used, it is determined that the power command cannot be performed. On the other hand, if there is enough information to transmit the power command, it is determined that the power command can be issued by short-range wireless communication. Also, if the communication time of the short-range wireless communication ensures the time sufficient to adjust the amount of power and transmit the power from the supply device 5 to the vehicle 3 by the time the vehicle 3 passes over the supply device 5, it is determined that the power command can be issued by short-range wireless communication. On the other hand, if the communication time of the short-range wireless communication is such that it is not possible to secure a time sufficient to adjust the power amount and transmit power from the supply device 5 to the vehicle 3 before the vehicle 3 passes over the supply device 5, it is determined that the power command cannot be issued by short-range wireless communication.

By adjusting the amount of power according to the power command by short-range wireless communication and transmitting power from the supply device 5 to the vehicle 3, the power from the supply device 5 and the power generated by the regenerative braking allows suppressing the occurrence of overcharging of the battery 320. Therefore, the vehicle ECU 330 does not prohibit the regenerative braking of the vehicle 3 when determining that the power command can be issued by the short-range wireless communication. On the other hand, if the vehicle ECU 330 determines that the power command cannot be issued by short-range wireless communication, and regenerative braking is performed, there is a possibility that the battery 320 will be overcharged by the power from the supply device 5 and the power from the regenerative braking. Therefore, the regenerative braking of the vehicle 3 is prohibited.

Further, if the compatibility check determines that the primary device 13 and the secondary device 22 are compatible and that the battery 320 is likely to be overcharged, the vehicle ECU 330 may determine, for example, whether to issue a power request to the supply device 5 by short-range wireless communication. Then, as predetermined charging control that is performed when there is a possibility that the battery 320 is overcharged, for example, the vehicle ECU 300 makes a power request by short-range wireless communication from the vehicle 3 to the supply device 5 when the brake of the vehicle 3 is ON, and does not makes a power request by short-range wireless communication from the vehicle 3 to the supply device 5 when the brake of the vehicle 3 is OFF.

Alternatively, the vehicle ECU 330 may determine that the power request is made through the short-range wireless communication when the accelerator of the vehicle 3 is OFF and the power is not requested through the short-range wireless communication when the accelerator of the vehicle 3 is ON. Further, the vehicle ECU 330 may determine that the power request is to be made through short-range wireless communication when the stop lamp switch of the vehicle 3 is ON. Further, the vehicle ECU 330 may determine that the electric power request through the short-range wireless communication is not performed when the stop lamp switch of the vehicle 3 is OFF.

Note that the vehicle ECU 330 may determine whether to make a power request to the supply device 5 by short-range wireless communication based on the maximum value Pw_max of power that the supply device 5 can transmit, the chargeable amount Win of the battery 320 of the vehicle 3, and the maximum value Pr_max of the amount of power resulting from regenerative braking that occurs when brake pedal operations of the vehicle 3 are performed. That is, vehicle ECU 330 determines that power is requested by short-range wireless communication when the relationship Win<Pw_max+Pr_max is satisfied. On the other hand, if the relationship Win<Pw_max+Pr_max is not satisfied, vehicle ECU 330 determines not to request power through short-range wireless communication.

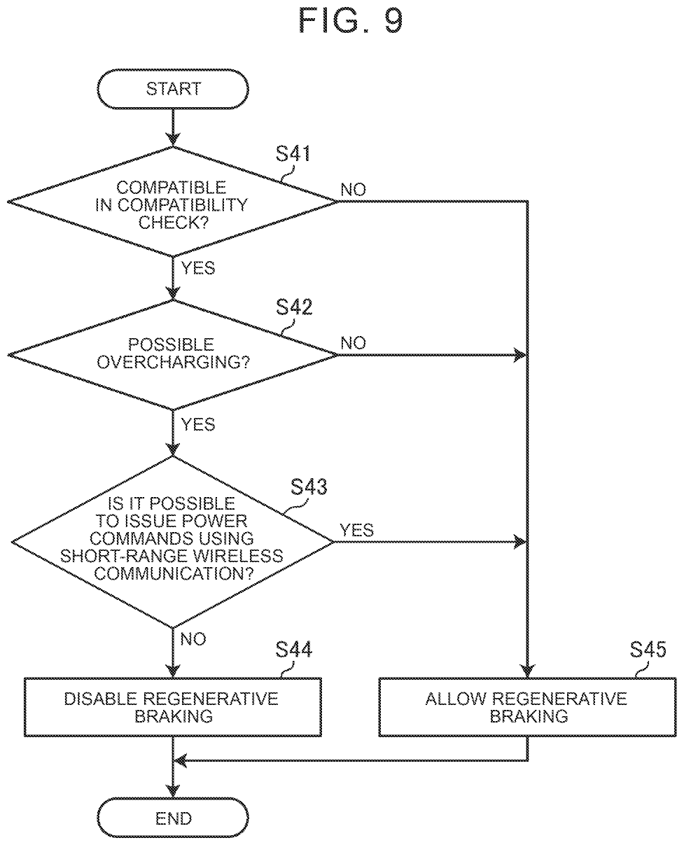

FIG. 9 is a flowchart showing an example of overcharge suppression control performed in the wireless power transfer system 1 according to the embodiment. Here, vehicle information including the required electric power is communicated between the vehicle 3 and the supply device 5 of the D-WPT lane that the vehicle 3 has approached or entered by wide area wireless communication.

First, the vehicle ECU 330 checks compatibility between the primary device 13 of the supply device 5 and the secondary device 22 of the vehicle 3 in a compatibility check performed with the supply device 5 of the D-WPT lane that the vehicle 3 approaches or enters. It is determined whether there is a property (S41). Next, when the vehicle ECU 330 determines that the primary device 13 and the secondary device 22 are compatible (Yes in S41), it is possible to overcharge the battery 320 of the vehicle 3 by power transmission from the supply device 5. It is determined whether there is a property (S42). When the vehicle ECU 330 determines that the battery 320 may be overcharged (Yes in S42), the vehicle ECU 330 determines whether it is possible to issue a power command to the supply device 5 through short-range wireless communication (S43). When vehicle ECU 330 determines that the power command cannot be issued by short-range wireless communication (No in S43), vehicle ECU 330 prohibits regenerative braking of vehicle 3 (S44). After that, vehicle ECU 330 terminates the series of controls.

On the other hand, when vehicle ECU 330 determines in S41 that primary device 13 and secondary device 22 are not compatible (No in S41), when the vehicle ECU 330 determines in S42 that battery 320 is unlikely to be overcharged (No in S42), or when the vehicle ECU 330 determines in S43 that the power command can be given by short-range wireless communication (Yes in S43), regenerative braking of the vehicle 3 is permitted (S45). After that, vehicle ECU 330 terminates the series of controls.

As a result, in the wireless power transfer system 1 according to the embodiment, it is possible to suppress unnecessary short-range wireless communication while suppressing overcharging of the battery 320 due to regenerative braking during non-contact power feeding while driving.

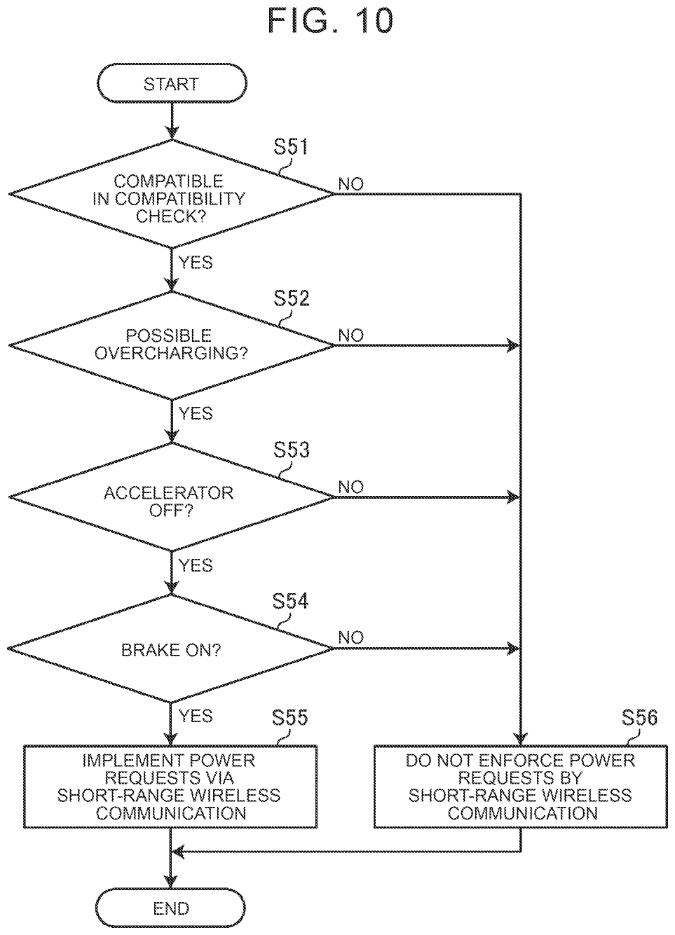

FIG. 10 is a flowchart showing another example of overcharge suppression control performed in the wireless power transfer system 1 according to the embodiment.

First, the vehicle ECU 330 determines whether there is compatibility between the primary device 13 of the supply device 5 and the secondary device 22 of the vehicle 3 in a compatibility check performed with the supply device 5 (S51). Next, when vehicle ECU 330 determines that primary device 13 and secondary device 22 are compatible (Yes in S51), vehicle ECU 330 determines whether battery 320 of vehicle 3 is likely to be overcharged (S52). When vehicle ECU 330 determines that battery 320 may be overcharged (Yes in S52), vehicle ECU 330 determines whether the accelerator of vehicle 3 is OFF (S53). When vehicle ECU 330 determines that the accelerator of vehicle 3 is OFF (Yes in S53), vehicle ECU 330 determines whether the brake of vehicle 3 is ON (S54). When vehicle ECU 330 determines that the brake of vehicle 3 is ON (Yes in S54), vehicle ECU 330 requests power through short-range wireless communication (S55). After that, vehicle ECU 330 terminates the series of controls.

On the other hand, when vehicle ECU 330 determines in S51 that primary device 13 and secondary device 22 are not compatible (No in S51), when the vehicle ECU 330 determines in S52 that battery 320 is unlikely to be overcharged (No in S52), when the vehicle ECU 330 determines that the accelerator of the vehicle 3 is ON in S53 (No in S53), or when the vehicle ECU 330 determines that the brake of the vehicle 3 is OFF in S54 (No in S54), the power request by the short-range wireless communication is not executed (S56). After that, vehicle ECU 330 terminates the series of controls.

As a result, in the wireless power transfer system 1 according to the embodiment, when regenerative braking is performed during non-contact power feeding while driving, a power request is made by short-range wireless communication, and overcharging of the battery 320 is suppressed while suppressing wasteful short-range wireless communication.

What is claimed is:

1. A traveling noncontact power supply system that supplies, in a noncontact manner, power from a road-side power supply device to a traveling vehicle in which a vehicle-side power receiving device is mounted, and charges a power storage device mounted on the vehicle, wherein:
the road-side power supply device includes a first communication device that performs wide-area wireless communication with the vehicle-side power receiving device, and a second communication device that performs narrow-area wireless communication with the vehicle-side power receiving device;
the vehicle-side power receiving device includes a third communication device that performs the wide-area wireless communication with the road-side power supply device, and a fourth communication device that performs the narrow-area wireless communication with the road-side power supply device;
the vehicle is able to charge the power storage device by performing regenerative braking; and
when compatibility between the road-side power supply device and the vehicle-side power receiving device is satisfied and there is a possibility that the power storage device is overcharged, predetermined charging control is performed through the narrow-area wireless communication, and when compatibility between the road-side power supply device and the vehicle-side power receiving device is satisfied and there is no possibility that the power storage device is overcharged, the predetermined charging control is not performed through the narrow-area wireless communication.

2. The traveling noncontact power supply system according to claim 1, wherein as the predetermined charging control, the regenerative braking is permitted when a power command is able to be issued from the vehicle-side power receiving device to the road-side power supply device through the narrow-area wireless communication, and the regenerative braking is prohibited when the power command is not able to be issued from the vehicle-side power receiving device to the road-side power supply device.

3. The traveling noncontact power supply system according to claim 1, wherein as the predetermined charging control, a power request is made from the vehicle-side power receiving device to the road-side power supply device through the narrow-area wireless communication when a brake of the vehicle is on, and no power request is made from the vehicle-side power receiving device to the road-side power supply device through the narrow-area wireless communication when the brake is off.
